(19) United States
(12) Patent Application Publication
(10) Pub. No.: US 2006/0074851 A1
(43) Pub. Date: Apr. 6, 2006

(54) Management of play count of content data

(76) Inventors: Michio Nagai, Akiruno-shi (JP); Yuji Horie, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/244,015

(22) Filed: Oct. 5, 2005

(30) Foreign Application Priority Data
Oct. 6, 2004 (JP) 2004-294020

(51) Int. Cl. G06F 17/30

(52) U.S. Cl. 707/1

(57) ABSTRACT

When a processing including transmission, reception, and/or deletion of content data is performed, a play count detecting unit detects play count of the content data stored in a portable terminal from a time when previous processing has been performed to a time when current processing has been performed, by comparing a first database with a third database, the first database managing play count of content data stored in an information processing apparatus and the third database managing play count of content data stored in the portable terminal. A first update unit reflects in the first database the detected play count. A second database which maintains play count every time the processing is performed is updated by a second update unit based on the first database in which play count has been updated by the first update unit. A third update unit updates the third database based on the second database.

### CROSS-REFERENCE TO RELATED APPLICATIONS

This application is based upon and claims the benefit of priority from prior Japanese Patent Application No. 2004-294020, filed Oct. 6, 2004, the entire contents of which are incorporated herein by reference.

### BACKGROUND OF THE INVENTION

1. Field of the Invention

The present invention relates to an information processing system for managing a play count of content data in the case where content data synchronization is carried out between a plurality of devices, and a method of managing a play count of content data.

2. Description of the Related Art

Conventionally, there has been proposed a variety of systems for transferring music data stored in a personal computer (PC) or the like to a portable terminal and playing and enjoying music at the portable terminal.

For example, U.S. 2004/0223245 A1 and U.S. 2005/0141367 A1 disclose a technique of transferring music number data to a portable audio playing apparatus from an audio server by using a transfer list. The music data transferred to the portable device is designed so as not to be played at the audio server side.

### BRIEF SUMMARY OF THE INVENTION

According to a first aspect of the present invention, there is provided an information processing system for carrying out at least one of transmission, reception, and deletion of content data between an information processing apparatus and a portable terminal, the system comprising:

a first database configured to manage play count of content data stored in the information processing apparatus;

a second database configured to maintain play count of content data every time the at least one of transmission, reception, and deletion is carried out;

a third database configured to manage play count of content data stored in the portable terminal;

a play count detecting unit configured to, when the at least one of transmission, reception, and deletion of the content data is carried out, detect play count of the content data stored in the portable terminal from a time when at least one of previous transmission, reception, and deletion has been carried out to a time when at least one of current transmission, reception, and deletion has been carried out, by comparing the first database and the third database with each other;

a first update unit configured to reflect in the first database the play count detected by the play count detecting unit;

a second update unit configured to update the second database on the basis of the first database in which play count of content data has been updated by the first update unit; and

a third update unit configured to update the third database on the basis of the second database.

According to a second aspect of the present invention, there is provided an information processing system for carrying out synchronization of content data between an information apparatus and a portable terminal, the system comprising:

a first database configured to manage play count of content data stored in the information processing apparatus;

a second database configured to maintain play count of content data every time the synchronization is carried out;

a third database configured to manage play count of content data stored in the portable terminal;

a play count detecting unit configured to, at the time of the synchronization of the content data, detect play count of content data stored in the portable terminal from a time when previous synchronization is carried out to a time when current synchronization is carried out, by comparing the second database and the third database with each other;

a first update unit configured to reflect in the first database the play count detected by the play count detecting unit;

a second update unit configured to update the second database on the basis of the first database in which play count of content data has been updated by the first update unit; and

a third update unit configured to update the third database on the basis of the second database.

According to a third aspect of the present invention, there is provided a content data play count management method of an information processing system for carrying out at least one of transmission, reception, and deletion of content data between an information processing apparatus and a portable terminal by using a first database configured to manage play count of content data stored in the information processing apparatus, a second database stored in the information processing apparatus, the second database being configured to maintain play count of content data every time the at least one of transmission, reception, and deletion of content data is carried out between the information processing apparatus and the portable terminal, and a third database stored in the portable terminal, the third database being configured to manage play count of content data stored in the portable terminal, the method comprising:

when the at least one of transmission, reception, and deletion of the content data is carried out, detecting play count of the content data stored in the portable terminal from a time when at least one of previous transmission, reception, and deletion has been carried out to a time when at least of current transmission, reception, and deletion has been carried out, by comparing the second database and the third database with each other;

reflecting the detected play count in the first database;

updating the second database on the basis of the first database in which play count of the content data has been updated; and

updating the third database on the basis of the second database.

According to a fourth aspect of the present invention, there is provided an information processing system for carrying out at least one of transmission, reception, and deletion of content data between an information processing apparatus and a portable terminal, the system comprising:

a first database for managing play count of content data stored in the information processing apparatus;

a second database for maintaining play count of content data every time the at least one of transmission, reception, and deletion is carried out;

a third database for managing play count of content data stored in the portable terminal;

play count detecting means for, when the at least one of transmission, reception, and deletion of the content data is carried out, detecting play count of the content data stored in the portable terminal from a time when at least one of previous transmission, reception, and deletion has been carried out to a time when at least one of current transmission, reception, and deletion has been carried out, by comparing the first database and the third database with each other;

first update means for reflecting in the first database the play count detected by the play count detecting means;

second update means for updating the second database on the basis of the first database in which play count of content data has been updated by the first update means; and

third update means for updating the third database on the basis of the second database.

According to a fifth aspect of the present invention, there is provided an information processing system for carrying out synchronization of content data between an information apparatus and a portable terminal, the system comprising:

a first database for managing play count of content data stored in the information processing apparatus;

a second database for maintaining play count of content data every time the synchronization is carried out;

a third database for managing play count of content data stored in the portable terminal;

play count detecting means for, at the time of the synchronization of the content data, detecting play count of content data stored in the portable terminal from a time when previous synchronization is carried out to a time when current synchronization is carried out, by comparing the second database and the third database with each other;

first update means for reflecting in the first database the play count detected by the play count detecting means;

second update means for updating the second database on the basis of the first database in which play count of content data has been updated by the first update means; and

third update means for updating the third database on the basis of the second database.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of an information processing system according to one embodiment of the present invention;

FIG. 2 is a conceptual diagram showing storage regions of an HDD of a PC main body and an HDD of a portable device;

FIG. 3A is a view showing a data structure of PCSyncDB and PDSyncDB;

FIG. 3B is a view showing a data structure of a control flag (:Ctrl Flag) in FIG. 3A;

FIG. 4A is a view showing a data structure of an image table (PhotoTBL) contained in MasterDB;

FIG. 4B is a view showing a data structure of a music number table (MusicTBL) contained in MasterDB;

FIG. 4C is a view showing a synchronization table (SynchronizationTBL) contained in MasterDB;

FIG. 4D is a view showing a data structure of a keyword table (KeywordTBL) contained in MasterDB;

FIG. 4E is a view showing a data structure of a device table (DeviceTBL) contained in MasterDB;

FIG. 4F is a view showing a data structure of a template table (TemplateTBL) contained in MasterDB;

FIG. 4G is a view showing a data structure of a project table (ProjectTBL) contained in MasterDB;

FIG. 4H is a view showing a play list table (PlayListTBL) contained in MasterDB;

FIG. 4I is a view showing a data structure of a play list item table (PlayListItemTBL) contained in MasterDB;

FIG. 5 is a flow chart of a process for playing music number content data in a portable device;

FIG. 6 is a flow chart of a synchronization process in a PC;

FIG. 7A is a view showing a first half portion of a detail flow chart of a content data synchronization subroutine in FIG. 6; and

FIG. 7B is a view showing a latter half portion of the detail flow chart of the content data synchronization subroutine in FIG. 6.

### DETAILED DESCRIPTION OF THE INVENTION

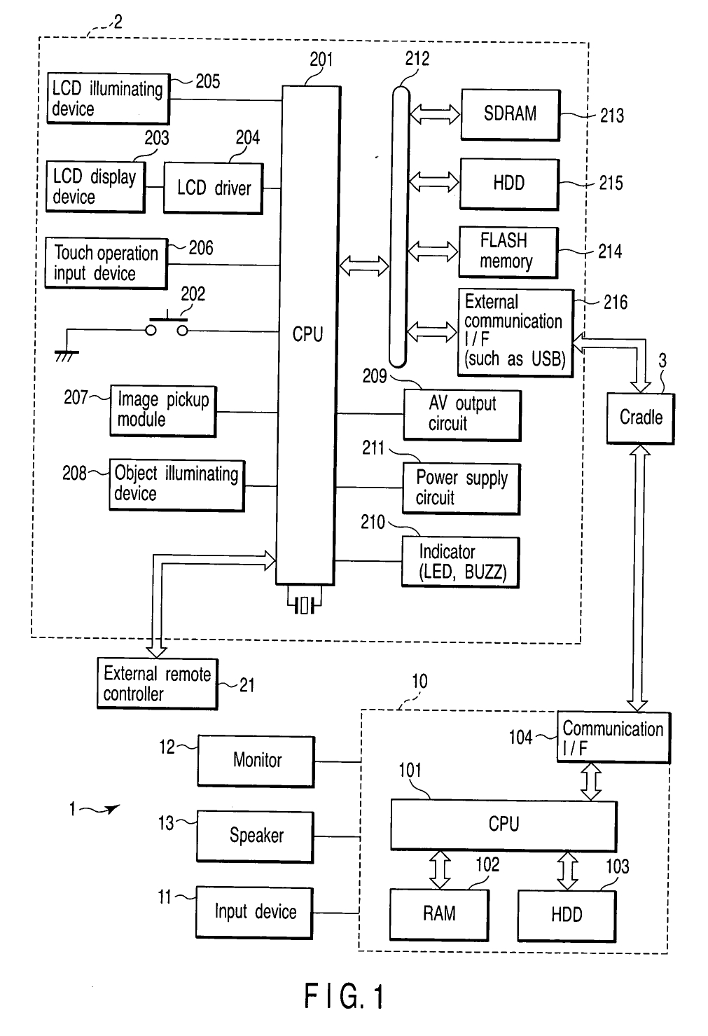

As shown in FIG. 1, an information processing system according to an embodiment of the present invention has: a personal computer (PC) 1 which is an information processing apparatus for storing content data; and a portable device 2 which is a portable terminal capable of acquiring and processing content data transmitted from the PC 1.

The PC 1 is composed of a PC main body, an input device 11 such as a keyboard or a mouse, and a monitor 12 and a speaker 13 serving as output devices. The PC main body 10 comprises a CPU 101 serving as a control unit, a RAM 102 utilized as a work region of the CPU 101, a hard disk drive (HDD) 103 which stores control programs or content data, and a communication interface (I/F) 104 such as a serial interface or a universal serial bus (USB) for making communication with an external device. Here, the content data stored in the HDD 103 includes image data, video data, music number data, text data and the like.

In addition, the portable device 2 comprises a CPU 201, a PWSW 202, an LCD display device 203, an LCD driver 204, an LCD illuminating device 205, a touch operation input device 206, an image pickup module 207, an object illuminating device 208, an AV output circuit 209, an indicator 210, a power supply circuit 211, a BUS 212, an SDRAM 213, a FLASH memory 214, an HDD 215, and an external communication I/F 216.

Here, the CPU 201 is a control unit which controls each unit in the portable device 2. The PWSW 202 is a power supply switch for switching start/stop of operation of the portable device 2 according to a user's operation.

The LCD display device 203 is a color liquid crystal display device for displaying content data such as an image or a video. The LCD driver 204 controls the LCD display device 203, and the LCD illuminating device 205 is a back light which illuminates the LCD display device 203. Further, the touch operation input device 206 is arranged on a display screen of the LCD display device 203, and senses a position touched by a user's finger or a pen. A touch panel is composed of the LCD display device 203, the LCD illuminating device 205, and the touch operation input device 206. The touch panel makes it possible to virtually achieve an operating key which the portable device 2 requires. Therefore, an operating key other than the PWSW 202 is not provided at the portable device 2 in particular.

The image pickup module 207 is a camera for photographing a still image or a moving image. The object illuminating device 208 illuminates an object by using a small sized light source such as an LED.

The AV output circuit 209 is a circuit for supplying video and audio signals to an external device such as a television set. The indicator 210 is an LED or a buzzer for indicating a state of the portable device 2 to the user by light or sound.

The power supply circuit 211 is intended to supply power required for an operation of each unit in the portable device 2 by means of a built-in battery or an external AC adapter, although not shown.

The BUS 212 is a transmission channel connected to the CPU 201, SDRAM 213, FLASH memory 214, HDD 215, and external communication I/F 216 for the purpose of transmitting an address and data. The SDRAM 213 is a memory which is utilized as a work region of the CPU 201. The FLASH memory 214 is a memory which stores a variety of data such as date data, and part of control programs, or a control parameter in a nonvolatile manner. The HDD 215 is a hard disk drive which stores control programs or content data acquired from the PC 1. The external communication I/F 216 is a communication interface such as a USB interface.

The external communication I/F 216 and the communication I/F 104 of the PC main body 10 may be directly connected to each other via a cable, and a cradle 3 is interposed between these interfaces as shown in FIG. 1, making it possible to carry out data communication. The cradle 3 used here is a stand type extension device in which the portable device 2 is placed, and comprises a function of interposing data communication and a function of electrically charging the portable device 2.

In addition, an external remote controller 21 for operating the portable device 2 can be connected to the CPU 201 of the portable device 2 via a remote controller terminal (not shown). Further, a headphone can be connected to the CPU 201 via a headphone terminal (not shown). The external remote controller 21 is configured as comprising a connecting unit for making connection to the remote controller terminal and the headphone terminal of the portable device 2, whereby the headphone may be connected to the headphone terminal provided at the external remote controller 21.

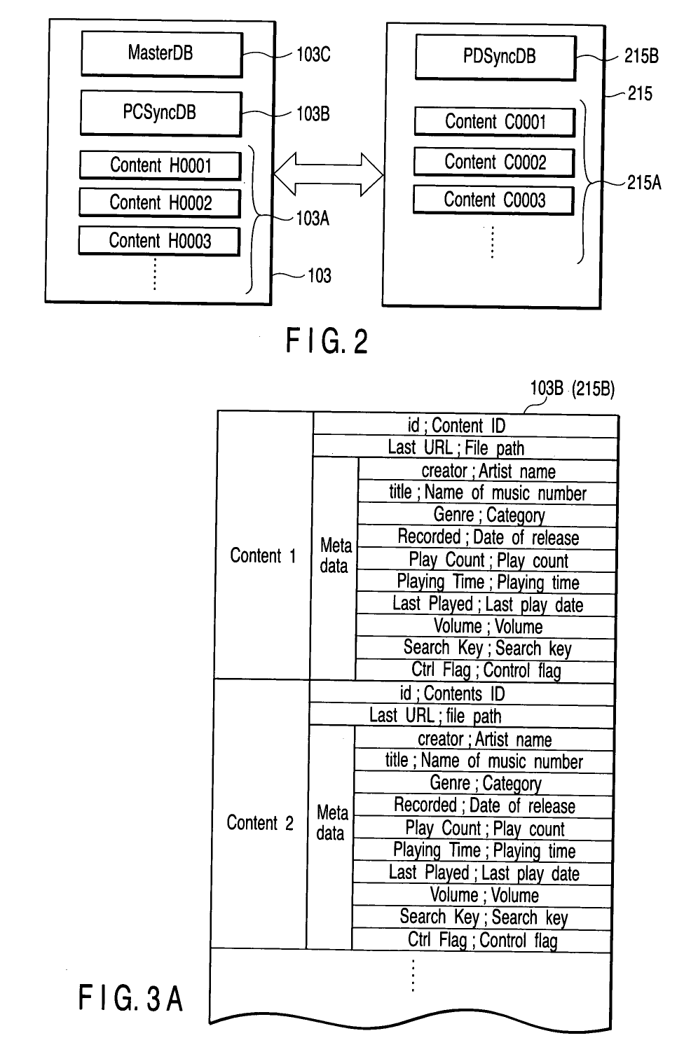

As shown in FIG. 2, a plurality of content data (content H0001, content H0002, content H0003, . . . ) 103A are stored in the HDD 103 of the PC main body 10. Further, the HDD 103 stores a PCSyncDB 103B which is a database having stored therein a variety of information indicating synchronization states of the PC 1 and portable device 2 and a MasterDB 103C which is a database having registered therein information relating to each of the content data. The contents of the PCSyncDB 103B used here are updated according to any operation relevant to the content data 103A contained in the PC 1. In FIG. 1, although only one portable device 2 is shown, it is possible to connect a plurality of portable devices to the PC 1 at the same time or individually. Thus, information for managing each portable device 2 is also registered in the MasterDB 103C.

Further, as in the HDD 215 of the portable device 2, a plurality of content data (content C0001, content C0002, content C0003, . . . ) 215A acquired from the PC 1 are designed to be stored, and a PDSyncDB 215B which is a database similar to the PCSyncDB 103B at the side of the PC 1 is designed to be stored. The contents of the PDSyncDB 215B are updated according to any operation relevant to the content data 215A contained in the portable device 2, although they are described in detail. When data synchronization with the PC 1 is carried out, the contents of the PDSyncDB 215B updated according to the contents of operation from the portable device 2 are sent to the side of the PC 1. In the PC 1, the contents of the PCSyncDB 103B are updated based on the above contents, and the updated contents of the PCSyncDB 103B are transmitted to the portable device 2. The portable device 2 receives the contents, and rewrites the contents of the PDSyncDB 215B.

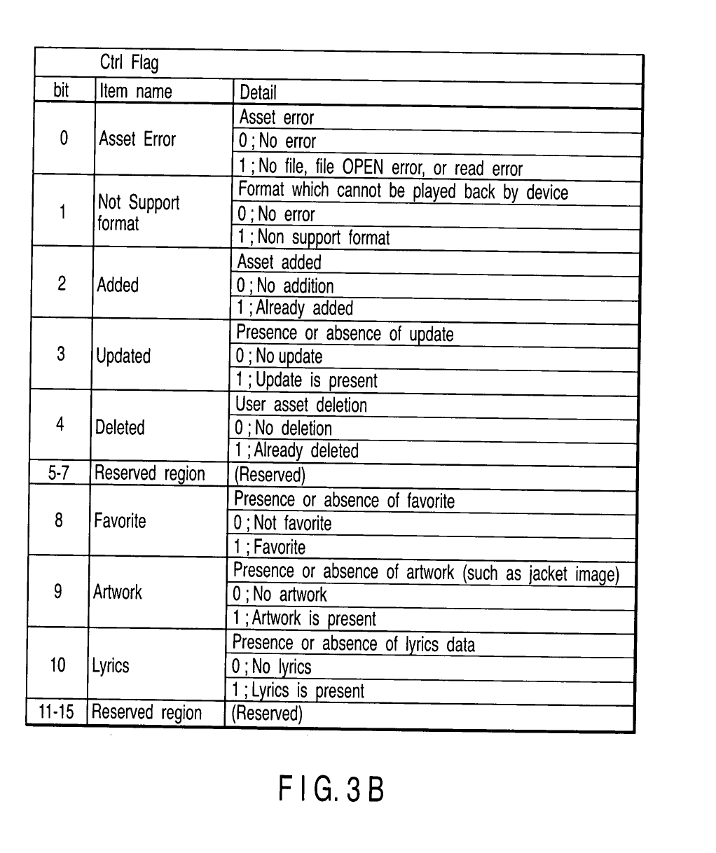

A data structure of these PCSyncDB 103B and PDSyncDB 215B is provided as shown in FIG. 3A. In actuality, these PCSyncDB 103B and PDSyncDB 215B are stored as files in an MPV (Multi Photo/Video) format which defines the specification of XML meta data for describing information on the content data. These files are created for content types such as an image, a video, or a music number. Now, a description will be given here by way of example in the case where the content type is music number data.

In the PCSyncDB 103B (or PDSyncDB 215B), a content ID (:id) for specifying the content data serving as a header and a file path (:Last URL) indicating a position on the HDD 103 (or HDD 215) at which the content data is stored, and meta data are stored for each of the content data. The meta data includes each item of data such as an artist name (:creator), a name of music number (:title), a category (:Genre), date of release (:Recorded), play count (:PlayCount), a playing time (:PlayingTime), a last play date (:LastPlayed), a volume (:Volume), a search key (:Search key), and a control flag (:Ctrl Flag).

The search key (:Search Key) used here is a keyword which the user can arbitrarily set in order to facilitate a search of content data.

A control flag (:Ctrl Flag) is composed of a total of 16 bits, as shown in FIG. 3B. That is, bit 0 is allocated to an asset error region (:Asset Error), bit 1 is allocated to a non-support format region (:Not Support Format), bit 2 is allocated to an asset added region (:Added), bit 3 is allocated to an update region (:Updated), bit 4 is allocated to a deleted region (:Deleted), bits 5 to 7 are allocated to reserved regions, bit 8 is allocated to a favorite region (:Favorite), bit 9 is allocated to an artwork region (:Artwork), bit 10 is allocated to a lyrics region (:Lyrics), and bits 11 to 15 are allocated to reserved regions.

The asset error region (:Asset Error) of bit 0 indicates whether or not an error exists in a combination of the content data and other content data (for example, in a combination of music number content data and image content data). When this bit 0 is set to “0”, it designates no error. When the bit is set to 1, it designates any one of no file, a file OPEN error, and a read error.

The non-support format region (:Not Support Format) of bit 1 indicates whether or not the asset is a format which cannot be played in the portable device 2. When this bit 1 is set to “0”, it designates no error, namely, a format which can be played. When the bit is set to “1”, it designates a non-support format, namely, a format which cannot be played. This format is not only support/non-support of a data compression format, but a format which cannot be played because playing is impossible in the case where a sampling frequency, an encoded bit rate or the like is not supported even if the compression format is supported.

The asset added region (:Added) of bit 2 indicates whether or not an asset has been added. When this bit 2 is set to “0”, it designates no asset has been added. When the bit is set to “1”, it designates that an asset has been added.

The updated region (:Updated) of bit 3 indicates whether or not any update exists for meta data relating to the content data. When this bit 3 is set to “0”, it designates that no update exists. When the bit is set to “1”, it designates that an update exists.

The deleted region (:Deleted) of bit 4 indicates whether or not an asset has been deleted by the user's operation. When this bit 4 is set to “0”, it designates that no asset has been deleted. When the bit is set to “1”, it designates that an asset has been deleted.

The favorite region (:Favorite) of bit 8 indicates whether or not a favorite has been specified by the user. When this bit 8 is set to “0”, it designates that no favorite has been specified. When the bit is set to “1”, it designates that a favorite has been specified. This makes it possible to extract only one specified to be a favorite.

The artwork region (:Artwork) of bit 9 indicates whether or not an artwork such as a jacket image exists. When this bit 9 is set to “0”, it designates that no artwork exists. When the bit is set to “1”, it designates that an artwork exists.

The lyrics region (:Lyrics) of bit 10 indicates whether or not lyrics data exists. When this bit 10 is set to “0”, it designates no lyrics exist. When the bit is set to “1”, it designates that a lyrics exists.

As described previously, the above PCSyncDB 103B and PDSyncDB 215B are created for each content type, and image content data and video content data each form a similar data structure, although the details on items are slightly different from each other. In addition, one database can register up to 1000 content data, for example, and a plurality of databases may be created even in the same content type, for example, providing another database from the 1001-th content data.

On the other hand, the above MasterDB 103C which only the PC 1 has is a relational database designated by nine tables, i.e., an image table (PhotoTBL) 103C1, a music number table (MusicTBL) 103C2, a synchronization table (SynchronizationTBL) 103C3, a keyword table (KeywordTBL) 103C4, a device table (DeviceTBL) 103C5, a template table (TemplateTBL) 103C6, a project table (ProjectTBL) 103C7, a play list table (PlayListTBL) 103C8, a play list item table (PlayListItemTBL) 103C9.

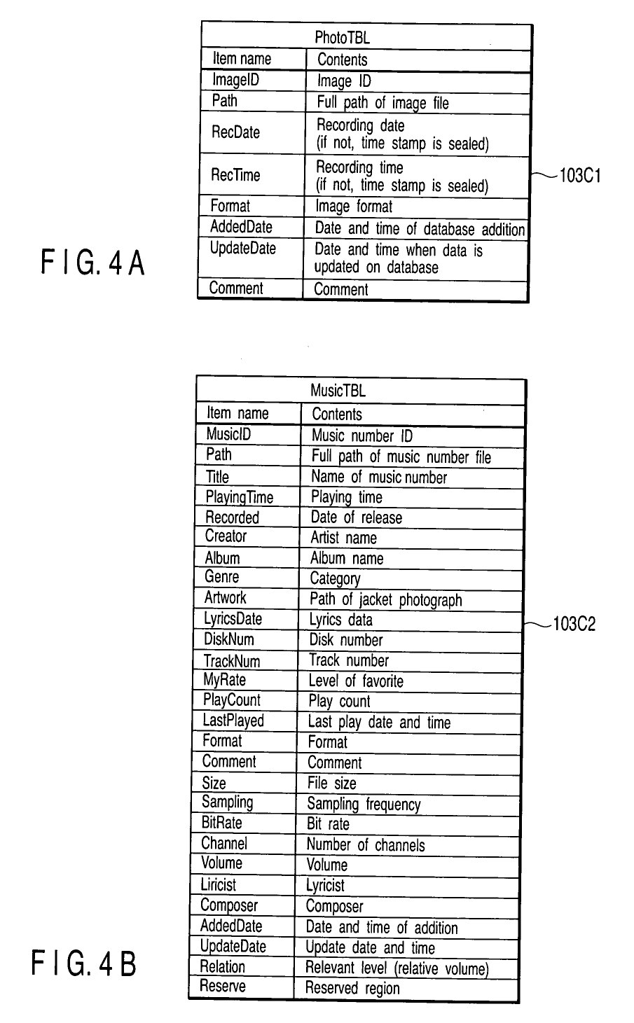

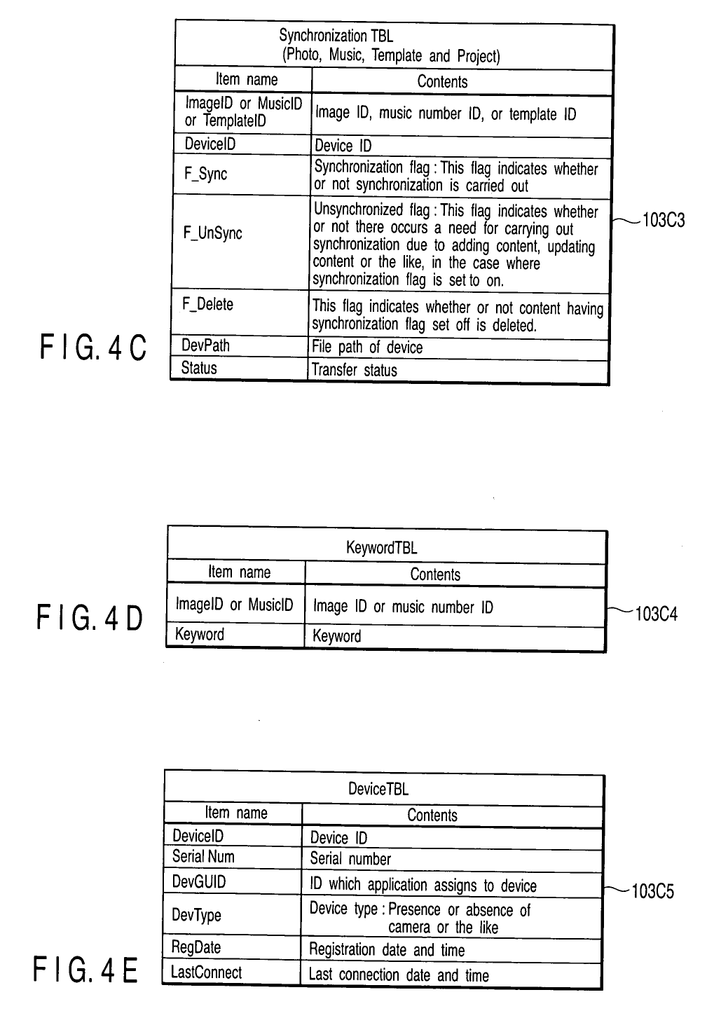

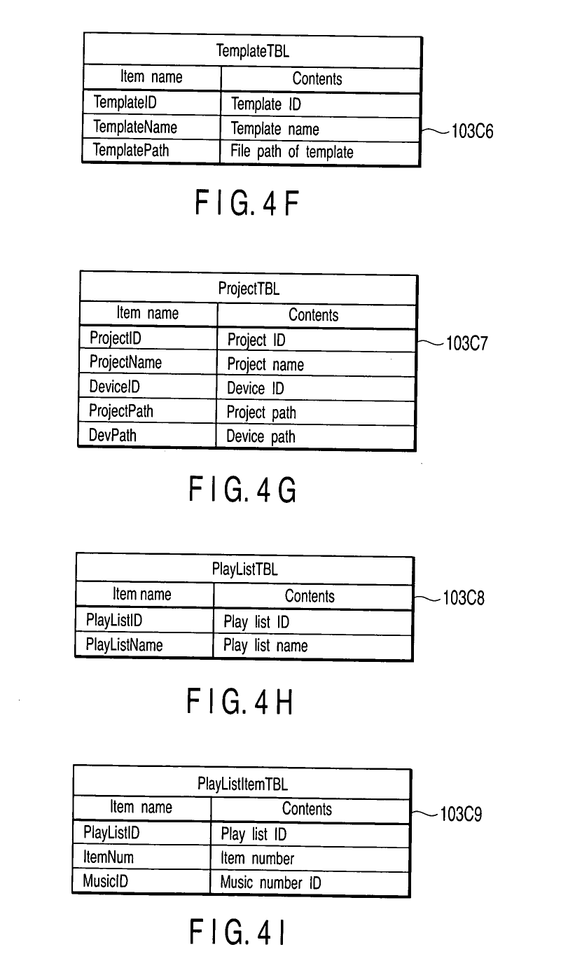

The PhotoTBL 103C1 is a table for managing image content data. In this table, as shown in FIG. 4A, eight items such as ImageID, Path, RecDate, RecTime, Format, AddedDate, UpdateDate, and Comment are defined. The item “ImageID” indicates an image ID for specifying image content data. The item “Path” indicates a full path of an image file. The item “RecDate” indicates a recording date (time stamp if nothing exists). The item “RecTime” indicates a recording time (time stamp if nothing exists). The item “Format” indicates an image format. The item “AddedDate” indicates a date and time when data has been added in database. The item “UpdateDate” indicates a date and time when data on a database has been updated. In addition, “Comment” indicates an arbitrary comment.

The above MusicTBL 103C2 is a table for managing music number content data. In this table, as shown in FIG. 4B, 28 items are defined, the items consisting of MusicID, Path, Title, PlayingTime, Recorded, Creator, Album, Genre, Artwork, LyricsData, DiskNum, TrackNum, MyRate, PlayCount, LastPlayed, Format, Comment, Size, Sampling, BitRate, Channel, Volume, Lyricist, Composer, AddedDate, UpdateDate, Relation, and Reserve. The item “MusicID” used here indicates a music number ID for specifying music number content data. The item “Path” indicates a full path of a music number file. The item “Title” indicates a name of music number. The item “PlayingTime” indicates a playing time. The item “Recorded” indicates a date of release of a CD album containing the music number. The item “Creator” indicates an artist name. The item “Album” indicates an album name. “Genre” indicates a category. The item “Artwork” indicates a path of a jacket photograph. The item “LyricsData” indicates lyrics data. The item “DiskNum” indicates a disk number. The item “TrackNum” indicates a track number. The item “MyRate” indicates a level of favorite. The item “PlayCount” indicates a play count. The item “LastPlayed” indicates a date and time of the last play. The item “Format” indicates a format. The item “Comment” indicates a comment. The item “Size” indicates a file size. The item “Sampling” indicates a sampling frequency. The item “BitRate indicates an encoded bite rate. The item “Channel” indicates the number of channels. The item “Volume” indicates a volume. The item “Lyricist” indicates a lyricist. The item “Composer” indicates a composer. The item “AddedDate” indicates a date and time of addition. The item “UpdateDate” indicates of an update date and time. The item “Relation” indicates a relation level (relevant volume). The item “Reserve” indicates a reserved region.

The SynchronizationTBL 103C3 is a database for synchronous management of image content data, music number content data, or templates, and is created for each content type. The template used here means a model of a reserved video effect such that the user can easily set a so-called slide show display for replacing an image in accordance with the performance of a music number, for example. In the SynchronizationTBL 103C3, as shown in FIG. 4C, seven items are defined, the items consisting of ImageID or MusicID or TemplateID, DeviceID, F_Sync, F_Unsync, F_Delete, DevPath, and State. The item “ImageID or MusicID or TemplateID” used here indicates an image ID, a music number ID, or a template ID. The item “DeviceID” indicates a device ID for specifying the portable device 2. The item “F_Sync” is a synchronization flag indicating whether or not synchronization is carried out. The item “F_Unsync” is an unsynchronization flag indicating whether or not there has occurred a need for carrying out synchronization by new addition, updating content and the like in the case where the synchronization flag (F_Sync) is set to on. The item “F_Delete” is a deleted flag indicating whether or not to delete content of which the synchronization flag (F_Sync) has been set to off. The item “DevPath” indicates a file path at the portable device 2. The item “Status” indicates a state of transfer.

The KeywordTBL 103C4 is a table for keyword management. In this table, as shown in FIG. 4D, two items, i.e., ImageID or MusicID and Keyword, are defined. The item “ImageID or MusicID” used here indicates an image ID or a music number ID. The item “Keyword” indicates a keyword.

The DeviceTBL 103C5 is a table for managing the portable device 2. In this table, as shown in FIG. 4E, six items are defined, the items consisting of DeviceID, SerialNum, DevGUID, DevType, RecDate, and LastConnect. The item “DeviceID” indicates a device ID. The item “SerialNum” indicates a serial number. The item “DevGUID” indicates an ID which is assigned to a device by an application. The item “DevType” indicates a device type of the presence or absence of a camera or the like. The item “RecDate” indicates a registration date and time. The item “LastConnect” indicates the last connection date and time.

The TemplateTBL 103C6 is a table for template management. In this table, as shown in FIG. 4F, three items are defined, the items consisting of TemplateID, TemplateName, and TemplatePath. The item “TemplateID” indicates a template ID. The item “TemplateName” indicates a template name. The item “TemplatePath” indicates a file path of a template.

The ProjectTBL 103C7 is a table for project management. The term “project” used here denotes describing a result of a so-called authoring work in which the user sets a play timing of each of the content data by arbitrarily combining the content data, as in the above slide display. In the ProjectTBL 103C7, five items are defined, the items consisting of ProjectID, ProjectName, DeviceID, ProjectPath, and DevPath. The item “ProjectID” used here indicates a project ID for specifying a project file. The item “ProjectName” indicates a project name. The item “DeviceID” indicates a device ID. The item “ProjectPath” indicates a project file path. In addition, the item “DevPath” indicates a file path at the portable device 2.

The PlayListTBL 103C8 is a table for play list management. The play list used here describes the play sequence of a plurality of content data. In this PlayListTBL 103C8, as shown in FIG. 4H, two items are defined, the items consisting of PlayListID and PlayListName. The item “PlayListID” used here indicates a play list ID for specifying a play list. In addition, the item “PlayListName” indicates a play list name.

The PlayListItemTBL 103C9 is a table for managing content data in a play list. In this table, as shown in FIG. 4I, three items are defined, the items consisting of PlayListID, ItemNum, and MusicID. The item “PlayListID” used here indicates a play list ID. The item “ItemNum” indicates an item number. In addition, the item “MusicID” indicates a music number ID.

Now, an operation of an information processing system having a configuration as described above will be described here.

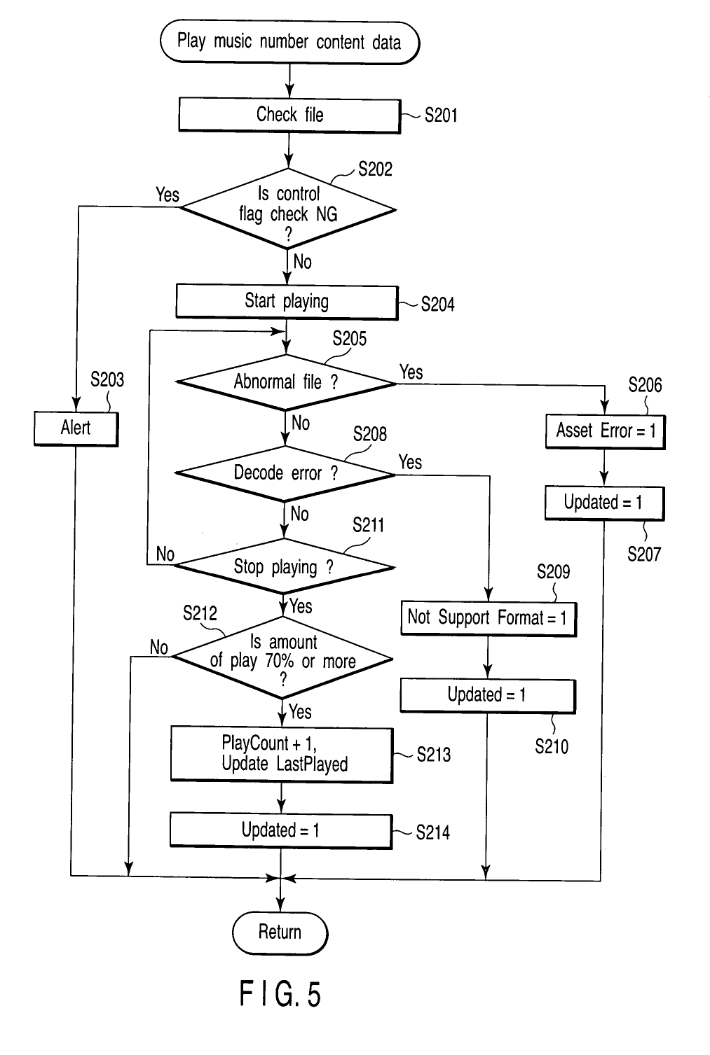

In the portable device 2, the CPU 201 executes a process of playing music number content data as shown in FIG. 5 in accordance with a control program stored in the FLASH memory 214 or HDD 215.

That is, first, management data is read out from the PDSyncDB 215B in accordance with the content ID (id) of music number content data to be played, and a file check of the music number content data is made (step S201). If a check result of a control flag (Ctrl Flag) is NG (step S202), an alerting is indicated (step S203), and this playing process is terminated. In this case, a control flag check is made as to whether or not an asset error (Asset Error) flag of bit 0 is set to “1” and further, as to whether or not a non-support format (Not Support Format) flag of bit 1 is set to “1”. If either of these flags is set to “1”, the check result of the control flag is NG. The above alerting may be indicated in any form such that an error message is displayed on the LCD display device 203 and the indicator 210 indicates the alerting to the user by sound and light.

On the other hand, when it has been determined that the check result of the control flag is not NG in the above step S202, playing of a file specified by a file path (Last URL) described next to the content ID of the music number content data is started (step S204).

Then, it is determined whether or not a failure has been detected in a file in the playing (step S205). When a file failure has been detected, the asset error (Asset Error) flag of bit 0 of the control flag (Ctrl Flag) of the music number content of the PDSyncDB 215B is set to “1” (step S206), and the updated (Updated) flag of bit 3 is set to “1” (step S207). Then, file playing is stopped, and this playing process is terminated. At this time, an error message indicating a reason for the end of play may be displayed on the LCD display device 203.

When a file failure has not been detected in the above step S205, it is further determined whether or not an occurrence of a decode error has been detected (step S208). Here, when an occurrence of a decode error has been detected, the non-support format (Not Support Format) flag of bit 1 of the control flag (Ctrl Flag) of the music number content data in the PDSyncDB 215B is set to “1” (step S209), and the updated (Updated) flag of bit 3 is set to “1” (step S210). Then, file playing is stopped, and this playing process is terminated. At this time, an error message indicating a reason for the end of play may be displayed on the LCD display device 203.

When the occurrence of the decode error has not been detected in the above step S208, it is determined whether or not play stop has occurred due to the user's play stop operation or the end of a file (step S211). Here, when play stop has not occurred, processing reverts to the above step S205.

Then, if play stop has occurred, it is determined whether or not play of a predetermined amount or more of the file has been made, for example, whether or not an amount of play is equal to or greater than 70% of the file (step S212). When it has been determined that play of the predetermined amount or more has not been completed, this playing process is terminated without executing any processing. In contrast, when play of the predetermined amount or more has been completed, “+1” is added to the play count (PlayCount) of the music number content data in the PDSyncDB 215B, and the last play date (LastPlayed) is updated to a date and time at the time of termination of playing (step S213). Then, the updated (Updated) flag of bit 3 of the control flag (Ctrl Flag) is set to “1” (step S214), and then, this playing process is terminated.

While processing of content data has been described by way of example of play of single music number content data, the above processing may be repeated in the case where a plurality of music number content data have been specified by a play list or the like. Further, of course, without being limited to the music number content data, image content data or video content data and a project obtained by properly combining content data of music numbers, images, and videos can be executed in the same manner as that in the playing process.

In addition, while the embodiment has described that the play count is equal to or greater than 70% of the file in amount of play, for example, it may be changed to a proper value such as 90% or more without being limited thereto. Alternatively, there is need for complicated processing if simplified determination of the play stop position is equal to or greater than 70% of the whole file is made. Conversely, if this process is further properly carried out, an amount of play of the content data is stored in advance, and it is possible to determine how many times play has been carried out based on a result obtained by adding an amount of the past play. In addition, a configuration may be provided as that these criteria can be set by the user.

Further, in this embodiment, the last play date (LastPlayed) is updated by using the date and time at the time of termination of playing, but a date and time at the time of start of playing can be used.

Now, a process of synchronizing content data stored in the PC 1 and the portable device 2 therebetween will be described here.

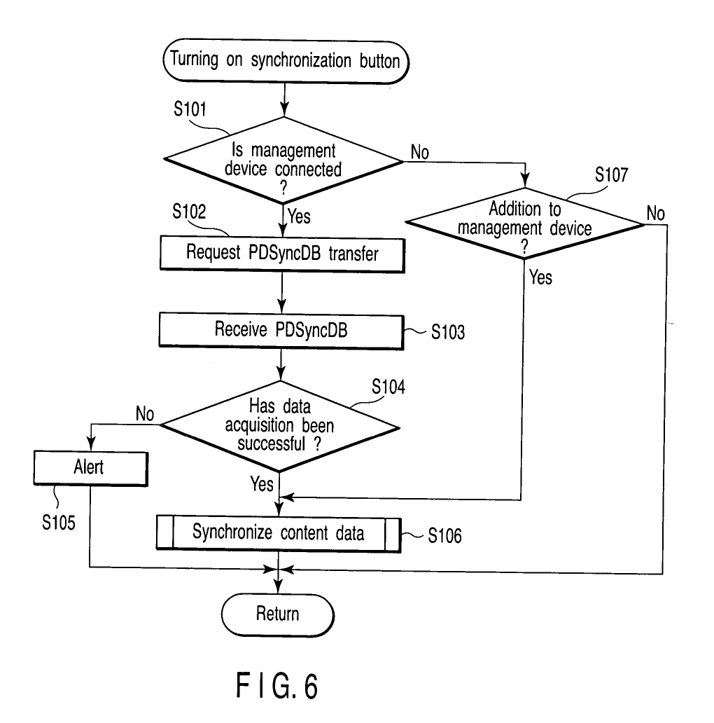

In the PC 1, the CPU 101 executes a synchronization process as shown in FIG. 6 in accordance with a control program stored in the HDD 103. This synchronization process is provided as a process in the case where a synchronization button arranged on a management screen (not shown) displayed as a window on the monitor 12 has been turned on by the user operation of the input device 11.

That is, first, it is determined whether or not a device managed by the MasterDB 103C is connected to the communication I/F 104 of the PC 1, namely, whether or not the portable device 2 which is directly connected or which is connected via the cradle 3 has been registered as a management device (step S101). Here, when the portable device 2 registered as a management device has been connected, a request for transferring the content data stored in the PDSyncDB 215B is transmitted to the portable device 2 (step S102).

Then, the CPU 101 receives the content data stored in the PDSyncDB 215B sent in response to this transfer request, and stores the data as a temporary file in the RAM 102 or HDD 103 (step S103). Here, it is determined whether or not the content data stored in the PDSyncDB 215B has been successfully acquired (step S104). When the acquisition is unsuccessful, an alerting is indicated by displaying an error message on the monitor 12, for example (step S105), and then, a synchronization process of the content data is terminated. When the acquisition has been successful, on the other hand, a content synchronization subroutine as described later is executed (step S106), and the synchronization process of the content data is terminated.

In the case where the portable device 2 which is not registered as a management device has been connected (step S101), a predetermined selection screen is displayed on the monitor 12, causing the user to select whether or not the connected portable device 2 is added as a management device (step S107). Then, when an adding instruction has been supplied, processing goes to the above step S106 in which the content data synchronization subroutine is executed. When no adding instruction has been supplied, the synchronization process of the content data is terminated.

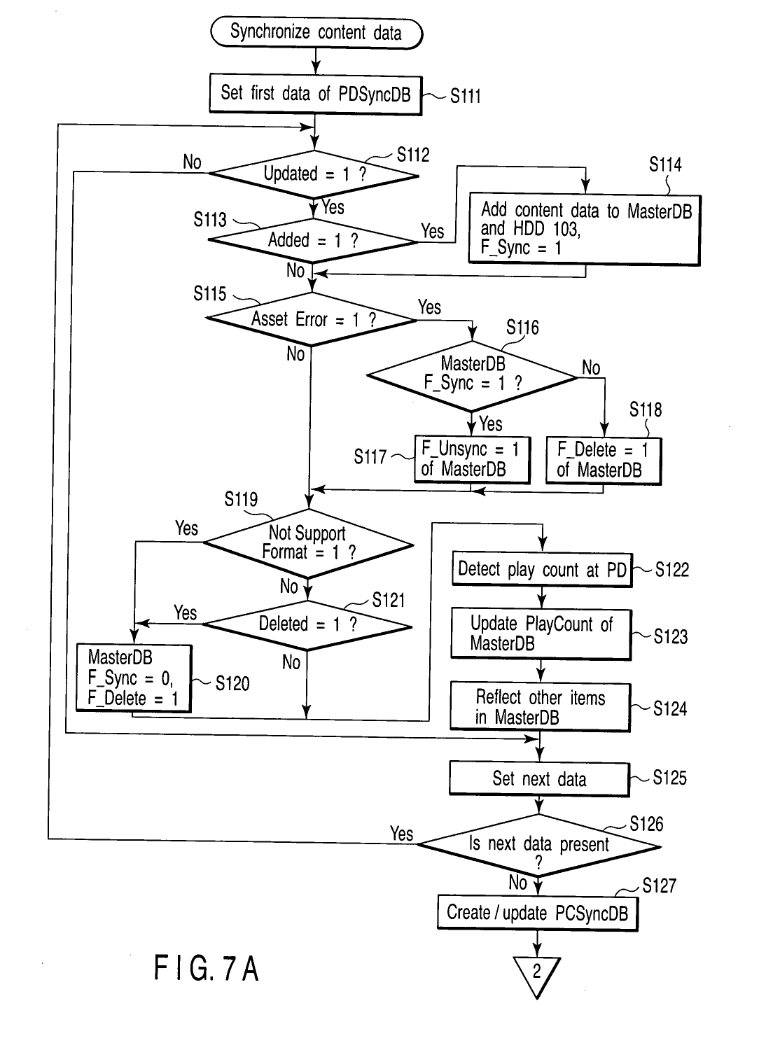

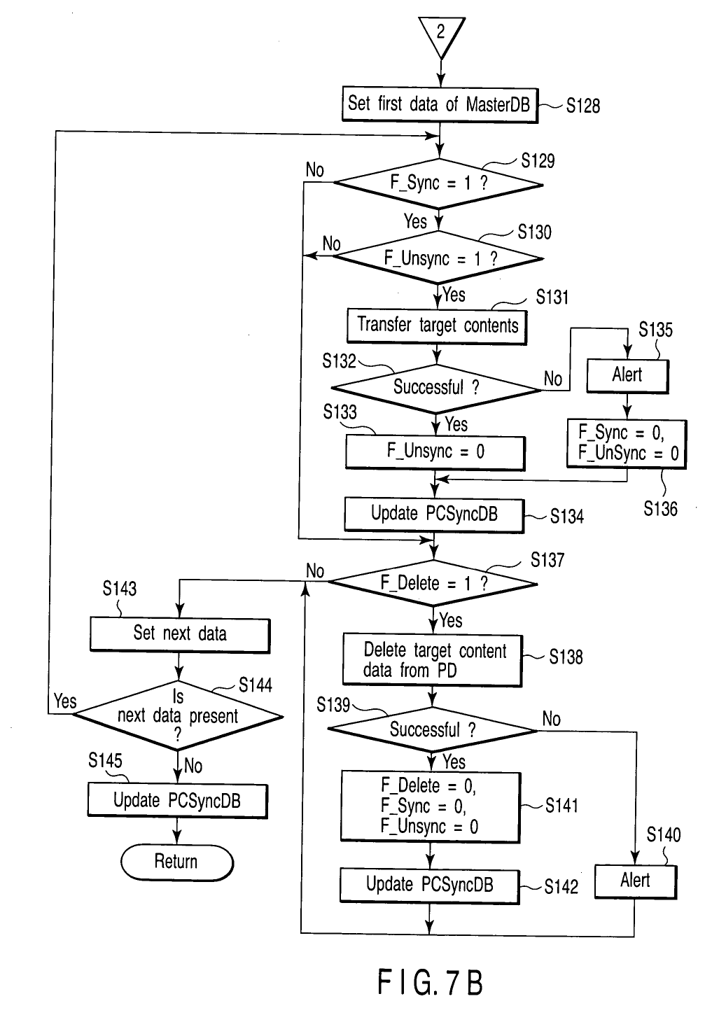

The content data synchronization subroutine called in the above step S106 is as shown in FIGS. 7A and 7B. That is, first, the first data stored in the PDSyncDB stored as the temporary file, namely, management data stored in content 1 is targeted to be processed, and is set to an internal counter (step S111). Then, it is determined whether or not the updated (Updated) flag of bit 3 of the control flag (Ctrl Flag) of the content data is set to “1” (step S112). When the flag is set to “0”, processing skips the subsequent steps S113 to S124, and proceeds to step S125.

In contrast, when the updated (Updated) flag is set to “1”, it is further determined whether or not the asset added (Added) flag of bit 2 of the control flag (Ctrl Flag) is set to “1” (step S113). Here, when the flag is set to “1”, it denotes that there exists a content newly added by the portable device 2 (image content data or project), and thus, data of the content data is added to the MasterDB 103C (step S114). That is, data is added to a content table (such as the PhotoTBL 103C1) and SynchronizationTBL 103C3 corresponding to the content data, and the synchronization flag (F_Sync) in the latter SynchonizationTBL 103C3 is set to ON (“1”). Also, the content data itself is copied to the HDD 103.

After the above setting, or alternatively, in the case where it has been determined that the asset added (Added) flag is not set to “1” in the above step S113, it is determined whether or not the asset error (Asset Error) flag of bit 0 of the above control flag (Ctrl Flag) is set to “1” (step S115). Here, when the flag is set to “1”, it is further determined whether or not the synchronization flag (F_Sync) in the SynchronizationTBL 103C3 of the content is set to “1” from the MasterDB 103C (step S116). Then, when the flag is set to “1”, the unsynchronization flag (F_Unsync) in the SynchronizationTBL 103C3 of the content of the MasterDB 103C is set to “1” (step S117). That is, in the case of an asset error, the MasterDB 103C is basically set so as to carry out retransfer. In contrast, in the case where the synchronization flag (F_Sync) is set to “0”, the deleted flag (F_Delete) in the SynchronizationTBL 103C3 of the content data of the MasterDB 103C is set to “1” (step S118).

After the above step S117 or step S118, or alternatively, in the case where it has been determined that the asset error (Asset Error) flag is not set to “1” in the above step S115, it is determined whether or not the non-support format (Not Support Format) flag of bit 1 of the above control flag (Ctrl Flag) is set to “1” (step S119). Here, when the flag is set to “1”, the synchronization flag (F_Sync) in the SynchronizationTBL 103C3 of the content data of the MasterDB 103C is set to “0” and the feleted flag (F_Delete) is set to “1” (step S120). Namely, when a non-support format error occurs, synchronization is reset.

When it has been determined that the non-support format (Not Support Format) flag is not set to “1” in the above step S119, it is further determined whether or not the deleted (Deleted) flag of bit 4 of the above control flag (Ctrl Flag) is set to “1” (step S121). Here, when the flag is set to “1”, processing proceeds to the above step S120.

Then, after the above step S120, or alternatively, in the case where it has been determined that the deleted (Deleted) flag is not set to “1” in the above step S121, the play count of the content data at the PC 1 is detected (step S122). This count can be detected by calculating a distance between the play count (PlayCount) of the content data in the PDSyncDB stored as a temporary file and the play count (PlayCount) of the content data in the PCSyncDB 103B. The play count (PlayCount) of a content table (for example, the MusicTBL 103C2) of the content of the MasterDB 103C is updated (i.e., added) based on the thus detected play count (step S123).

Then, with respect to other items, the above data is reflected in the MasterDB 103C similarly (step S124). However, this process will suffice with respect to items which can be at the portable device 2 such as favorite (Favorite) or last play date (LastPlayed).

After processing has been thus carried out with respect to one content data, the next data stored in the PDSyncDB stored as the temporary file, namely, management data stored in the next content data is targeted to be processed, and is set at an internal counter (step S125). In this case, if such next management data exists (step S126), processing reverts to the above step S112 in which the process described previously is repeated.

When the result in step S107 is affirmative and the present routine is executed, steps S111 to S126 are skipped since there is no existing PDSyncDB.

If processing has been terminated with respect to all the management data stored in the PDSyncDB, it is determined that the next management data does not exist in the above step S126. In this case, creating or updating the PCSyncDB 103B is carried out (step S127). That is, in the case of creating the PCSyncDB 103B, a database in which the synchronization flag (F_Sync) is set to “1” and the unsynchronization flag (F_Unsync) is set to “0”, or alternatively, the synchronization flag (F_Sync) is set to “0” and the unsynchronization flag (F_Unsync) is set to “1” is created based on the SynchronizationTBL 103C3 of the MasterDB 103C. In addition, when the PCSyncDB 103B already exists and is updated, overwrite operation is carried out.

Then, a process of transferring or deleting actual content data is executed. For that purpose, first, the first data stored in the MasterDB 103C is targeted to be processed, and is set at an internal counter (step S128). This process sets the first data stored in the SynchronizationTBL 103C3 in order to sequentially process the content data.

Then, it is determined whether or not the synchronization flag (F_Sync) is set to “1” (step S129). Here, when the flag is set to “0”, processing skips the subsequent steps S130 to S136, and proceeds to step S137. In addition, when the above synchronization flag (F_Sync) is set to “1”, it is further determined whether or not the unsynchronization flag (F_Unsync) is set to “1” (step S130). In this case as well, when the flag is set to “0”, processing proceeds to step S137.

In contrast, when the unsynchronization flag (F_Unsync) is set to “1”, target content data which is an unsynchronized file is transferred to the portable device 2, namely, is copied to the portable device 2 (step S131). Then, it is determined whether or not that transfer has been successful (step S132). Here, when transfer has been successful, the above unsynchronization flag (F_Unsync) is set to “0” (step S133), and the PCSyncDB 103B is updated based on a management table of the corresponding content data of the MasterDB 103C (step S134). When transfer has failed, on the other hand, an alerting is indicated by displaying an error message indicating the fact on the monitor 12, for example (step S135). The above synchronization flag (F_Sync) and unsynchronization flag (F_Unsync) are set to “0” (step S136), and then, processing proceeds to the above step S134 in which the PCSyncDB 103B is updated.

After the above step S134, or alternatively, in the case where it has been determined that the synchronization flag (F_Sync) is not set to “1” in the above step S129 or in the case where it has been determined that the unsynchronization flag (F_Unsync) is not set to “1” in the above step S130, it is determined whether or not F_Delete is set to “1” (step S137). Here, when the flag is set to “0”, processing skips the subsequent steps S138 to S142, and proceeds to step S143.

In contrast, when the above F_Delete is set to “1”, the target content data is deleted from the portable device 2 (step S138). Then, it is determined whether or not that deletion has been successful (step S139). Here, when deletion has failed, an alerting is indicated by displaying an error message indicating the fact on the monitor 12, for example (step S140). In addition, when deletion has been successful, the above F_Delete, synchronization flag (F_Sync), and unsynchronization flag (F_Unsync) are set to “0” altogether (step S141), and the PCSyncDB 103B is updated (step S142).

Then, after the above step S140 or step S142, or alternatively, in the case where it has been determined that the above F_Delete is not set to “1” in the above step S137, the next data stored in the MasterDB 103C is targeted to be processed, and is set at an internal counter (step S143). Namely, the next content data stored in the SynchronizationTBL 103C3 is set. In this case, if such next data exists (step S144), processing reverts to the above step S129, and the process as described previously is repeated.

In contrast, when a process has been terminated with respect to all the content data, it is determined that the next data does not exist in the above step S144. In this case, updating the PDSyncDB 215B is carried out (step S145). Namely, the PCSyncDB 103B updated in the above step S134 is copied to the portable device 2. Then, the content data synchronization subroutine is terminated, and processing returns to the upper routine.

As has been described above in detail, in the present embodiment, when a play error has occurred at the time of playing the content data transferred (synchronized) from PC 1 to the portable device 2, the same file is set so as to be transferred again, if this play error has occurred as a result of disabling play caused by destruction of a file containing the content data transferred to the portable device 2. In addition, when a play error has occurred as a result of disabling play due to failure to ensure compatibility with that file at the portable device 2 although the content file itself is normal, “synchronization” is reset so as not to carry out transfer. As described above, synchronization of content data between the PC 1 and the portable device 2 is controlled according to type of content data play error at the portable device 2. For this reason, it is possible to properly carry out a synchronization process of content data between the PC 1 and the portable device 2.

At the time of synchronization, the content of the PDSyncDB 215B is transferred to the PC 1, the play count at the portable device 2 is detected by comparing the transferred content with that contained in the PCSyncDB 103B, and the detected play count is reflected in the MasterDB 103C. Therefore, with respect to the content data synchronized between the PC 1 and the portable device 2 as well, the play count at both of the PC and the device can be properly managed.

From the foregoing specific embodiments, the inventions having the following features can be excerpted apart from the matters as claimed in the claims.

(1) An information processing system having an information processing apparatus which stores content data and a portable terminal configured which enables acquisition and processing of the content data transmitted from the information processing apparatus, the system comprising:

a transmission unit configured to transmit content data from the information processing apparatus to the portable terminal;

a content data processing unit configured to process the transmitted content data;

an error detecting unit configured to, in the case where an error has occurred when the content data is processed by the content data processing unit, detect the error;

an error information storage unit configured to store error information when an occurrence of the error has been detected by the error detecting unit; and

a control unit configured to control at least one of the transmission unit and the content data processing unit on the basis of the error information stored in the error information storage unit.

(2) The system according to (1), wherein

the content data processing unit is configured to enable play of the content data stored in the portable terminal; and

the error detecting unit detects an error when the content data is played by the portable terminal.

(3) The system according to (1), wherein

the error detecting unit is configured to enable detection of type of the error; and

the control unit controls at least one of the transmission unit and the content data processing unit according to type of the error detected by the error detecting unit.

(4) The system according to (3), wherein

the error detecting unit is configured to enable detection of any one of an error caused by a data failure of the content data and an error caused by a failure to ensure compatibility with a data format of the content data stored in the portable terminal as type of the error; and

the control unit controls to transmit the content data to the portable terminal from the information processing apparatus when the error detecting unit has detected the error caused by the data failure, and controls to delete the content data stored in the portable terminal when the error detecting unit has detected the error caused by the failure to ensure compatibility with the data format.

(5) An information processing system for carrying out synchronization of content data stored in an information processing apparatus and a portable terminal therebetween, the system comprising:

a content data management unit including synchronization management data for managing which of the content data stored in the information processing apparatus is synchronized with the content data stored in the portable terminal;

a synchronization processing unit configured to carry out a synchronization process between the content data stored in the information processing apparatus and the content data stored in the portable terminal on the basis of the synchronization management data stored in the content data management unit; and

a content data processing unit configured to process the content data stored in the portable terminal, wherein

in the case where the error has occurred when the content data is processed by the content data processing unit, the content data management unit changes the synchronization management data stored in the content data management unit according to the error.

(6) The system according to (5), wherein, when the error is caused by a failure of content data attempted to be processed by the content data processing unit, the content data management unit changes the synchronization management data stored in the content data management unit so as to synchronize the content data with each other again.

(7) The system according to (5), wherein, when the error is caused by a data format of content data attempted to be processed by the content data processing unit, the content data management unit changes the synchronization management data stored in the content data management unit so as not to synchronize the content data with each other again.

(8) The system according to (7), wherein the error caused by the data format of the content data is an error such that, when content data is played in the content data processing unit, an encoded bit rate of the content data exceeds a range which can be supported by the content data processing unit, and the content data cannot be normally played.

(9) An information processing system having an information processing apparatus which stores content data and a portable terminal configured which enables acquisition and processing of the content data transmitted from the information processing apparatus, the information processing system comprising:

the information processing apparatus including:
a content data management unit configured to manage which of the content data stored in the information processing apparatus is transmitted to the portable terminal; and
a transmission unit configured to transmit to the portable terminal the content data stored in the information processing apparatus on the basis of setting of the content data management unit; and

the portable terminal including:
a receiving unit configured to receive the content data transmitted by the transmission unit of the information processing apparatus; and
a content data processing unit configured to process the content data received by the receiving unit;
an error detecting unit configured to, in the case where an error has occurred when the content data is processed by the content data processing unit, detect the error; and
an error storage unit configured to store error information on the error detected by the error detecting unit, wherein

the content data management unit of the information processing apparatus acquires the error information stored in the error storage unit of the portable terminal, and provides setting of content data to be transmitted to the portable terminal on the basis of the acquired error information.

(10) An information processing system having an information processing apparatus which stores content data and a portable terminal configured which enables acquisition and processing of the content data transmitted from the information processing apparatus, the information processing system comprising:

the information processing apparatus including:
a content data management unit configured to manage at least one of transmitting to the portable terminal which of the content data stored in the information processing apparatus and deleting which of the content data stored in the portable terminal; and
a transmission unit configured to transmit to the portable terminal at least one of the content data stored in the information processing apparatus, and a deletion instructing signal for instructing deletion of the content data stored in the portable terminal, on the basis of the setting of the content data management unit; and

the portable terminal including:
a receiving unit configured to receive any one of the content data and the deletion instructing signal transmitted by the transmission unit of the information processing apparatus;
a content data processing unit configured to process the content data received by the receiving unit;
a deletion unit configured to delete the content data stored in the portable terminal in accordance with the deletion instructing signal received by the receiving unit;
an error detecting unit configured to, in the case where an error has occurred when the content data is processed by the content data processing unit, detect the error; and
an error storage unit configured to store error information on the error detected by the error detecting unit, wherein

the content data management unit of the information processing apparatus acquires the error information stored in the error storage unit of the portable terminal, and provides setting at least one of the content data transmitted to the portable terminal and the content data deleted from the portable terminal, on the basis of the acquired error information.

(11) A content synchronization method for carrying out synchronization of content data stored in an information processing apparatus and a portable terminal therebetween, the method comprising:

detecting whether or not an error has occurred when content data is processed in the portable terminal;

determining type of the error; and

controlling synchronization of the content data according to the type of the error.

(12) The method according to (11), wherein

the determination of the type of the error is made as to either of whether or not the error is caused by a failure of the content data and whether or not the error is caused by a data format of the content data; and

synchronization of the content data is controlled so as to synchronize the content data with each other again when the error is caused by the failure of the content data, and is controlled so as not to synchronize the contents with each other when the error is caused by the data format of the content data.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An information processing system for carrying out at least one of transmission, reception, and deletion of content data between an information processing apparatus and a portable terminal, the system comprising:
a first database configured to manage play count of content data stored in the information processing apparatus;
a second database configured to maintain play count of content data every time the at least one of transmission, reception, and deletion is carried out;
a third database configured to manage play count of content data stored in the portable terminal;
a play count detecting unit configured to, when the at least one of transmission, reception, and deletion of the content data is carried out, detect play count of the content data stored in the portable terminal from a time when at least one of previous transmission, reception, and deletion has been carried out to a time when at least one of current transmission, reception, and deletion has been carried out, by comparing the first database and the third database with each other;
a first update unit configured to reflect in the first database the play count detected by the play count detecting unit;
a second update unit configured to update the second database on the basis of the first database in which play count of content data has been updated by the first update unit; and
a third update unit configured to update the third database on the basis of the second database.

2. The system according to claim 1, wherein the information processing apparatus and the portable terminal each are configured to play the same items of content data independently.

3. The system according to claim 1, wherein the play count detecting unit calculates a difference in play count stored in the second database from play count stored in the third database, and detects play count of the content data stored in the portable terminal.

4. The system according to claim 1, wherein the first update unit adds the play count detected by the play count detecting unit to the play count stored in the first database.

5. The system according to claim 1, wherein the third update unit updates the third database by overwriting the third database by the second database.

6. The system according to claim 1, wherein update of the database by the first to third update units is carried out every time the at least one of transmission, reception, and deletion of the content data is carried out.

7. The system according to claim 1, further comprising a play count counting unit configured to, when a play end position of content data is equal to or greater than a predetermined value at the time of play of the content data, increase play count of the content data stored in any one of the first database and the second database.

8. An information processing system for carrying out synchronization of content data between an information apparatus and a portable terminal, the system comprising:
a first database configured to manage play count of content data stored in the information processing apparatus;
a second database configured to maintain play count of content data every time the synchronization is carried out;
a third database configured to manage play count of content data stored in the portable terminal;
a play count detecting unit configured to, at the time of the synchronization of the content data, detect play count of content data stored in the portable terminal from a time when previous synchronization is carried out to a time when current synchronization is carried out, by comparing the second database and the third database with each other;
a first update unit configured to reflect in the first database the play count detected by the play count detecting unit;
a second update unit configured to update the second database on the basis of the first database in which play count of content data has been updated by the first update unit; and
a third update unit configured to update the third database on the basis of the second database.

9. A content data play count management method of an information processing system for carrying out at least one of transmission, reception, and deletion of content data between an information processing apparatus and a portable terminal by using a first database configured to manage play count of content data stored in the information processing apparatus, a second database stored in the information processing apparatus, the second database being configured to maintain play count of content data every time the at least one of transmission, reception, and deletion of content data is carried out between the information processing apparatus and the portable terminal, and a third database stored in the portable terminal, the third database being configured to manage play count of content data stored in the portable terminal, the method comprising:
when the at least one of transmission, reception, and deletion of the content data is carried out, detecting play count of the content data stored in the portable terminal from a time when at least one of previous transmission, reception, and deletion has been carried out to a time when at least of current transmission, reception, and deletion has been carried out, by comparing the second database and the third database with each other;
reflecting the detected play count in the first database;
updating the second database on the basis of the first database in which play count of the content data has been updated; and
updating the third database on the basis of the second database.

10. An information processing system for carrying out at least one of transmission, reception, and deletion of content data between an information processing apparatus and a portable terminal, the system comprising:
a first database for managing play count of content data stored in the information processing apparatus;
a second database for maintaining play count of content data every time the at least one of transmission, reception, and deletion is carried out;
a third database for managing play count of content data stored in the portable terminal;
play count detecting means for, when the at least one of transmission, reception, and deletion of the content data is carried out, detecting play count of the content data stored in the portable terminal from a time when at least one of previous transmission, reception, and deletion has been carried out to a time when at least one of current transmission, reception, and deletion has been carried out, by comparing the first database and the third database with each other;
first update means for reflecting in the first database the play count detected by the play count detecting means;
second update means for updating the second database on the basis of the first database in which play count of content data has been updated by the first update means; and
third update means for updating the third database on the basis of the second database.

11. An information processing system for carrying out synchronization of content data between an information apparatus and a portable terminal, the system comprising:
a first database for managing play count of content data stored in the information processing apparatus;
a second database for maintaining play count of content data every time the synchronization is carried out;
a third database for managing play count of content data stored in the portable terminal;
play count detecting means for, at the time of the synchronization of the content data, detecting play count of content data stored in the portable terminal from a time when previous synchronization is carried out to a time when current synchronization is carried out, by comparing the second database and the third database with each other;
first update means for reflecting in the first database the play count detected by the play count detecting means;
second update means for updating the second database on the basis of the first database in which play count of content data has been updated by the first update means; and
third update means for updating the third database on the basis of the second database.
